(19) United States
(12) Patent Application Publication
(10) Pub. No.: US 2014/0115317 A1
(43) Pub. Date: Apr. 24, 2014

(54) ELECTRONIC DEVICE AND METHOD FOR SWITCHING WORK MODE OF THE ELECTRONIC DEVICE

(71) Applicant: Hon Hai Precision Industry Co., Ltd., New Taipei (TW)

(72) Inventors: SHENG-WEI SU, New Taipei (TW); PO-WEI WANG, New Taipei (TW); CHIN-HUNG WANG, New Taipei (TW)

(73) Assignee: HON HAI PRECISION INDUSTRY CO., LTD., New Taipei (TW)

(21) Appl. No.: 14/033,472

(22) Filed: Sep. 22, 2013

(30) Foreign Application Priority Data
Oct. 23, 2012 (TW) 101139156

(51) Int. Cl. G06F 9/44

(52) U.S. Cl. CPC G06F 9/4401
USPC 713/100

(57) ABSTRACT

In a method for switching a work mode of an electronic device, if the electronic device receives a trigger signal when the electronic device is starting up, the electronic device enters the diagnostic mode. Otherwise, if the electronic device does not receive the trigger signal when the electronic device is starting up, the electronic device enters a production mode. When the electronic device receives the trigger signal in the production mode, operation parameters of the electronic device are stored into a storage system, and the electronic device switches from the production mode to the diagnostic mode. When the electronic device receives an exit command in the diagnostic mode, the electronic device switches from the diagnostic mode to the production mode.

### BACKGROUND

1. Technical Field

The embodiments of the present disclosure relate to systems and methods for controlling electronic devices, and particularly to an electronic device and a method for switching a work mode of the electronic device.

2. Description of Related Art

An electronic device can work in a diagnostic mode or a production mode. In the diagnostic mode, the electronic device controls execution of firmware of the electronic device (e.g., executing the firmware step by step), so that the firmware can be debugged and functions of the electronic device can be tested. In the production mode, the electronic device executes the firmware normally and provides various functions of the electronic device to users. The work mode of the electronic device can be switched when the electronic device is starting up. After the electronic device has started, a user has to reset the electronic device in order to switch the work mode of the electronic device.

### BRIEF DESCRIPTION OF THE DRAWINGS

FIG. 1 is one embodiment of an electronic device including a switching system.

FIG. 2 is a block diagram of one embodiment of function modules of the switching system of the electronic device in FIG. 1.

FIG. 3 is a flowchart of one embodiment of a method for switching a work mode of the electronic device in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives.

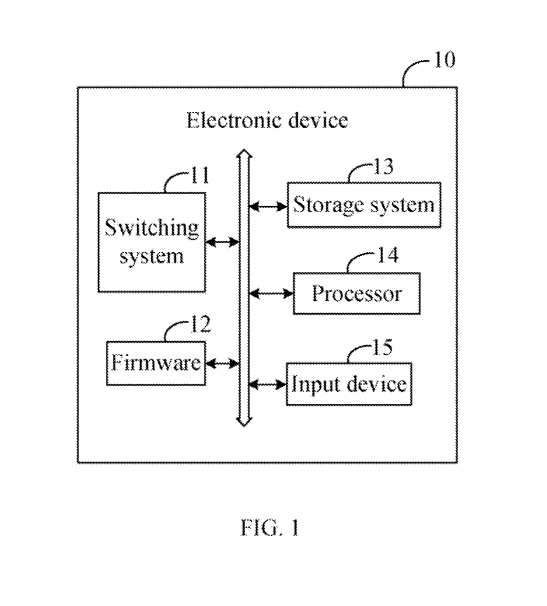

FIG. 1 is one embodiment of an electronic device 10 including a switching system 11. The electronic device 10 further includes a firmware 12. A work mode of the electronic device 10 is a diagnostic mode or a production mode. In the diagnostic mode, the electronic device 10 controls execution of the firmware 12, so that the firmware 12 can be debugged and functions of the electronic device 10 can be tested. In the production mode, the electronic device 10 executes the firmware 12 normally and provides various functions of the electronic device 10 to users. The switching system 11 allows the electronic device 10 to switch the work mode conveniently.

The electronic device 10 further includes a storage system 13, at least one processor 14, and an input device 15. The storage system 13 may be a dedicated memory, such as an EPROM, a hard disk drive (HDD), or flash memory. In some embodiments, the storage system 13 may also be an external storage device, such as an external hard disk, a storage card, or other data storage medium. The input device 15 may be a mouse or a keyboard.

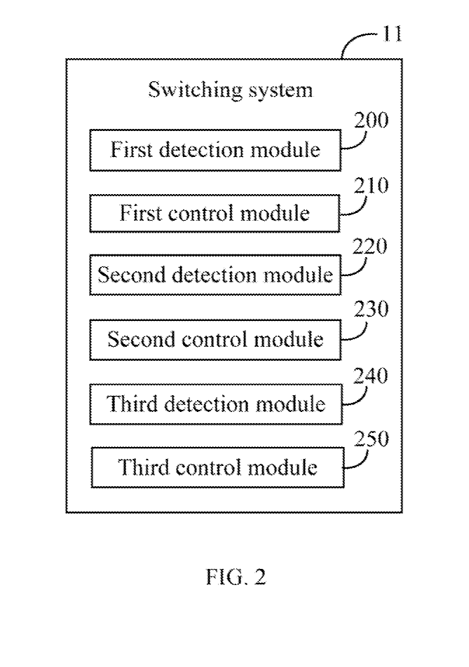

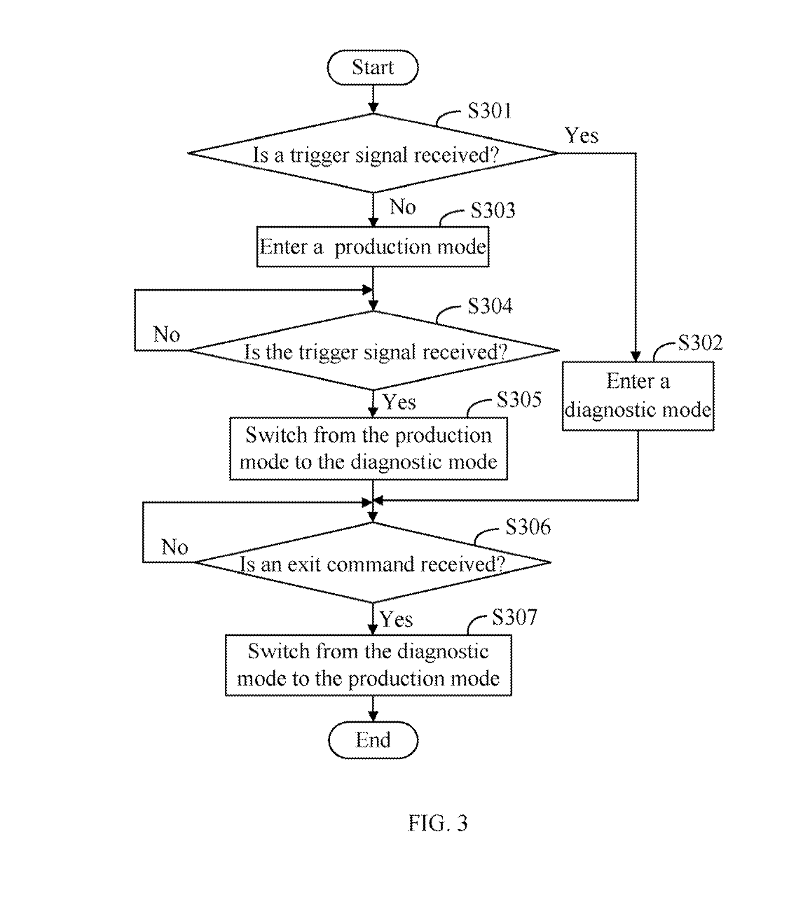

FIG. 2 is a block diagram of one embodiment of function modules of the switching system 11 shown in FIG. 1. The switching system 11 includes a first detection module 200, a first control module 210, a second detection module 220, a second control module 230, a third detection module 240, and a third control module 250. The modules 200-250 may comprise computerized code in the form of one or more programs that are stored in the storage system 13. The computerized code includes instructions that are executed by the at least one processor 14, to provide the aforementioned functions of the switching system 11. A detailed description of the functions of the modules 200-250 is given below in reference to FIG. 3.

FIG. 3 is a flowchart of one embodiment of a method for switching a work mode of the electronic device in FIG. 1. Depending on the embodiment, additional steps may be added, others removed, and the ordering of the steps may be changed.

When the electronic device 10 is starting up, in step S301, the first detection module 200 detects whether the electronic device 10 receives a trigger signal for entering a diagnostic mode. In one embodiment, the electronic device 10 receives the trigger signal from a specified port (e.g., a serial port) of the electronic device 10. The trigger signal may be a predetermined code, such as an American Standard Code for Information Interchange (ASCII), or an external interrupt.

If the electronic device 10 receives the trigger signal when the electronic device 10 is starting up, in step S302, the first control module 210 controls the electronic device 10 to enter the diagnostic mode. Then the procedure goes to step S306.

Otherwise, in step S301, if the electronic device 10 does not receive the trigger signal, in step S303, the first control module 210 controls the electronic device 10 to enter a production mode. In one embodiment, the electronic device 10 executes a plurality of production processes in the production mode. Each of the production processes implements one or more functions of the electronic device 10. For example, the electronic device 10 executes a network process to provide a network function, executes a display process to provide a display function, and executes an audio/video process to provide an audio/video function.

In step S304, the second detection module 220 detects whether the electronic device 10 receives the trigger signal when the electronic device 10 is in the production mode.

When the electronic device 10 receives the trigger signal in the production mode, in step S305, the second control module 230 stores operation parameters of the electronic device 10 into the storage system 13, and controls the electronic device 10 to switch from the production mode to the diagnostic mode. The operation parameters of the electronic device 10 describe an operation environment and an operation state of the electronic device 10 in the production mode.

In this embodiment, the electronic device 10 executes a plurality of production processes in the production mode. In this case, when the electronic device 10 receives the trigger signal in the production mode, the second control module 230 stores operation parameters of all the production processes into the storage system 13, suspends all the production processes, and controls the electronic device 10 to enter the diagnostic mode.

The second control module 230 may execute a diagnostic process to control the electronic device 10 to switch from the production mode to the diagnostic mode. When the electronic device 10 receives the trigger signal in the production mode, the diagnostic process notifies the production processes to enter a suspend state, and controls the electronic device 10 to enter the diagnostic mode.

When the electronic device 10 is in the diagnostic mode, in step S306, the third detection module 240 detects whether the electronic device 10 receives an exit command for exiting the diagnostic mode. The exit command may be sent by a user from the input device 15. In one example, the input device 15 is a key board. The user presses an escape button on the keyboard to send the exit command.

When the electronic device 10 receives the exit command in the diagnostic mode, in step S307, the third control module 250 controls the electronic device 10 to switch from the diagnostic mode to the production mode. In one embodiment, the third control module 250 determines whether the storage system 13 stores operation parameters of the electronic device 10. If the storage system 13 stores the operation parameters of the electronic device 10, the third control module 250 restores the production mode of the electronic device 10 according to the operation parameters stored in the storage system 13, and then deletes the operation parameters from the storage system 13. If the storage system 13 does not store operation parameters of the electronic device 10, the third control module 250 controls the electronic device 10 to exit the diagnostic mode and enter the production mode.

In this embodiment, a plurality of production processes are executed by the electronic device 10 in the production mode. The operation parameters of the production processes are stored in the storage system 13. If the electronic device 10 receives the exit command, the third control module 250 re-executes the production processes according to the operation parameters of the production processes. The third control module 250 may use the diagnostic process to notify the production processes to exit from the suspend state and re-execute.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method for switching a work mode of an electronic device being executed by a processor of the electronic device, the method comprising:
detecting whether the electronic device receives a trigger signal for entering a diagnostic mode when the electronic device is starting up;
when the electronic device receives the trigger signal, controlling the electronic device to enter the diagnostic mode, and when the electronic device does not receive the trigger signal, controlling the electronic device to enter a production mode;
detecting whether the electronic device receives the trigger signal when the electronic device is in the production mode;
when the electronic device receives the trigger signal in the production mode, storing operation parameters of the electronic device into a storage system, and controlling the electronic device to switch from the production mode to the diagnostic mode;
detecting whether the electronic device receives an exit command for exiting the diagnostic mode when the electronic device is in the diagnostic mode; and
when the electronic device receives the exit command in the diagnostic mode, controlling the electronic device to switch from the diagnostic mode to the production mode.

2. The method of claim 1, wherein the trigger signal is a predetermined code or an external interrupt.

3. The method of claim 1, wherein the electronic device executes a plurality of production processes in the production mode.

4. The method of claim 3, wherein the electronic device executes a diagnostic process to notify the production processes to enter a suspend state and control the electronic device to enter the diagnostic mode, when the electronic device receives the trigger signal in the production mode.

5. The method of claim 1, wherein the electronic device controls execution of firmware of the electronic device in the diagnostic mode and executes the firmware normally in the production mode.

6. An electronic device, comprising:
at least one processor; and
a storage system storing a plurality of instructions, which when executed by the at least one processor, cause the at least one processor to:
detect whether the electronic device receives a trigger signal for entering a diagnostic mode when the electronic device is starting up;
when the electronic device receives the trigger signal, control the electronic device to enter the diagnostic mode, and when the electronic device does not receive the trigger signal, control the electronic device to enter a production mode;
detect whether the electronic device receives the trigger signal when the electronic device is in the production mode;
when the electronic device receives the trigger signal in the production mode, store operation parameters of the electronic device into the storage system, and control the electronic device to switch from the production mode to the diagnostic mode;
detect whether the electronic device receives an exit command for exiting the diagnostic mode when the electronic device is in the diagnostic mode; and
when the electronic device receives the exit command in the diagnostic mode, control the electronic device to switch from the diagnostic mode to the production mode.

7. The electronic device of claim 6, wherein the trigger signal is a predetermined code or an external interrupt.

8. The electronic device of claim 6, wherein the electronic device executes a plurality of production processes in the production mode.

9. The electronic device of claim 8, wherein the electronic device executes a diagnostic process to notify the production processes to enter a suspend state and control the electronic device to enter the diagnostic mode, when the electronic device receives the trigger signal in the production mode.

10. The electronic device of claim 6, wherein the electronic device controls execution of firmware of the electronic device in the diagnostic mode and executes the firmware normally in the production mode.

11. A non-transitory computer-readable storage medium storing a set of instructions, the set of instructions capable of being executed by a processor of an electronic device to implement a method for switching a work mode of the electronic device, the method comprising:
detecting whether the electronic device receives a trigger signal for entering a diagnostic mode when the electronic device is starting up;
when the electronic device receives the trigger signal, controlling the electronic device to enter the diagnostic mode, and when the electronic device does not receive the trigger signal, controlling the electronic device to enter a production mode;
detecting whether the electronic device receives the trigger signal when the electronic device is in the production mode;
when the electronic device receives the trigger signal in the production mode, storing operation parameters of the electronic device into a storage system, and controlling the electronic device to switch from the production mode to the diagnostic mode;
detecting whether the electronic device receives an exit command for exiting the diagnostic mode when the electronic device is in the diagnostic mode; and
when the electronic device receives the exit command in the diagnostic mode, controlling the electronic device to switch from the diagnostic mode to the production mode.

12. The storage medium of claim 11, wherein the trigger signal is a predetermined code or an external interrupt.

13. The storage medium of claim 11, wherein the electronic device executes a plurality of production processes in the production mode.

14. The storage medium of claim 13, wherein the electronic device executes a diagnostic process to notify the production processes to enter a suspend state and control the electronic device to enter the diagnostic mode, when the electronic device receives the trigger signal.

15. The storage medium of claim 11, wherein the electronic device controls execution of firmware of the electronic device in the diagnostic mode and executes the firmware normally in the production mode.
